(19) United States
(12) Patent Application Publication
(10) Pub. No.: US 2006/0100967 A1
(43) Pub. Date: May 11, 2006

(54) Electronic pricing system, device and method

(76) Inventors: Salvatore Grimaldi, Stockholm (SE); Bjorn Nilsson, Jarlasa (SE)

Correspondence Address: YOUNG & THOMPSON, 745 SOUTH 23RD STREET, 2ND FLOOR, ARLINGTON, VA, 22202, US

(21) Appl. No.: 10/525,774

(22) PCT Filed: Aug. 28, 2003
(86) PCT No.: PCT/SE03/01333

§ 371 Date: Sep. 30, 2005

(30) Foreign Application Priority Data
Aug. 28, 2002 (SE) 0202565-8

(51) Int. Cl. G06F 17/00; G06G 7/00

(52) U.S. Cl. 705/400; 705/35

(57) ABSTRACT

An electronic pricing system, includes price label system server adapted to communicate with a price controlling application (PCA) server communicating price label information to price labels (PLs). The system is designed to generate control signals for updating price information related to at least two separate sales items that are both/all logically linked to an individual price label in the system, the price label being designed to receive the control signals and to display the price information for each item separately.

### TECHNICAL FIELD

The present invention relates to an electronic pricing system, device and method according to the preambles of independent claims. More specifically, the invention relates to an electronic pricing system capable of associating two or more separate sales items to one individual price label supported by the system.

### TECHNICAL BACKGROUND

The price label system according to the present invention is generally an electronic pricing and information system that replaces the old paper labels with electronic labels where the prices on labels can be wirelessly changed from a computer.

The actual price changes are not done in the price label system, but in the store's Price Controlling Application (PCA) system. The PCA contains a database which stores all the information about the items in the store, e.g. product name, package size, and the current price. The store's cash registers are connected to the PCA system, and thus always have the correct price information. The PCA can e.g. be the store's back-office computer system. There are no limitations regarding host computers for the PCA and the price label system server. They may be run on the same computer or in two (or more) different computers.

The PCA system controls the actual price of an item and provides the price label system according to the invention with updating information whenever the price is changed. The PCA system interacts with the price label system to supply information to the price labels (PLs). This is normally performed via a Price File Interface (PFI) that is a software-to software interface connecting the PCA system to the price label system server. The only prerequisite is that all PFI files (see below) are reachable (can be read and written) within any path of a mounted drive or file system known to the computer where the PFI service is executing. The transportation mechanisms through the PFI are e.g. common text files, e.g. in 8-bit ASCII format or 2-byte UNICODE. Other transportation mechanisms are naturally possible. The price label system automatically detects the format of the input files. Two PFI files are created by the PCA, a message file and a data file. The price label system creates a third PFI file, a result file that is retrieved by the PCA.

The message file contains one or many commands to the price label, e.g. a target link command used to establish the connection between an item and a label and an update command used to change the information on the label, e.g. the price.

The data file contains data such as prices, item identity and label identity (price label ID) and the result file contains the results from executed commands.

The price label system generally comprises software installed in a server computer, a hardware infrastructure and price labels. The hardware infrastructure comprises base stations, transceivers and cables. The price labels are mounted with their items in the store, e.g. on the shelf-edges. Transceivers are normally mounted in the ceiling and base stations normally on a wall. A predetermined number of transceivers are connected to a base station, which is connected to the price label system server, preferably via a hub. The price label server is connected to the PCA, often via the same network.

FIG. 1 schematically illustrates an overview of the PCA and the price label system briefly described above and in accordance with well-established technique where the present invention is applicable.

When a price is changed in the PCA system, the information is sent to the price label system server (PLS server). From the PLS server, designated as “server” in FIG. 1, the information is sent via a hub and base stations BS to transceivers in the ceiling where it is transformed into infrared signals. When the electronic price labels receive the infrared signals the price is immediately updated.

Each electronic price label acknowledges the updated price by transmitting a feedback pulse to the transceivers. The feedback pulse is returned to the server and stored in a database to verify that the transmission was OK.

Although the system shown in FIG. 1 uses infrared signals when communicating with the price label it should be noted that the present invention is equally applicable for any type of communication signal used between the price label system and the price labels. Among different types of communication signal applicable in the system can be mentioned radio wave signals, optical signals, electrical signals.

A cell is defined as the set of transceivers connected to the same base station. A sub-cell is defined as each set of simultaneously transmitting transceivers. All transceivers within a sub-cell simultaneously transmit the same data. A power supply energizes the transmitting transceivers.

A price label (PL) is an electronic device provided with an LCD display that is supplied by electric and electronic components for driving the display. The internal components and the LCD display are supported in a casing which may be sized for mounting the price label onto the forward edge of a store shelf, e.g. Each PL has a unique address and is logically connected to a sales item in the store. Normally the PL displays an item's price. FIG. 2a shows a typical price label where all fields are active and FIG. 2b shows a price label displaying normal price and normal unit price. A sender and transmitter part 2 and a small solar cell 4 can also be seen on the price label in FIG. 2b. A battery, or a combination of battery and solar cell, provides the power for the PL.

There exists many different kinds of price labels, they can e.g. differ in size, in number of price fields or other fields. The word “price” is used throughout the application to define what is displayed on the price label. It should however be noted that although the price label often displays price information it is naturally possible to display other type of information on the price labels, solely or in addition to price information, without departing from the scope of the present invention. This other type of information may for example be text, figures or images.

The labels can also differ in the way the price label system needs to handle them, e.g. with regard to used communication protocol, and if the circuitry inside the price label has been changed.

For further details on an electronic pricing system suitable for implementing the improvements suggested by the present invention, see e.g. WO 02/05171 A1 and WO 02/05058 A2.

### OBJECTS OF THE INVENTION

The objects of the present invention are to further enhance the performance of an electronic pricing system substantially as discussed above. More specifically, one object of the present invention is to provide en electronic pricing system with improved exploitation of accessible shelf space for displaying sales items in stores.

Another object is to provide a space saving price label in an electronic pricing system with improved exploitation of shelf edge space for price labels, thus permitting a more condense display of small sized items on the shelf, e.g.

Yet another object of the present invention is to provide an electronic pricing system and price label with enhanced update speed in price changes on the price labels.

Still another object is to provide an electronic pricing system that permits a reduction of the number of price labels required for displaying prices on sales items in a store.

A further object of the present invention is to provide a system and price label airing towards a reduction of costs for production and implementation of the electronic pricing system.

A still further object is to provide a solution for an electronic pricing system and a price label that overrules the limitations for downscaling of price label size, set by the physical components that supply and support the price information display.

### SUMMARY OF THE INVENTION

The above-mentioned objects and aims are achieved by an electronic pricing system, price label and method as defined by the appended independent claims. Preferred embodiments are set forth in subordinated claims depending there from.

Briefly, the present invention foresees that two or several sales items are logically linked to an individual price label supported by the system, and the price label being arranged to display price information associated with each separate item linked to that price label.

### SHORT DESCRIPTION OF DRAWINGS

FIG. 1 is a schematic illustration of a price controlling application system and a price label system according to well-established technique and wherein the present invention is applicable;

FIGS. 2a and 2b show typical prior art price labels used by the prior art electronic pricing system;

FIG. 3 is a block diagram illustrating the relationships between different hardware and software objects in an electronic pricing system suitable for implementation of the invention;

FIG. 4 shows the main blocks of an electronic pricing system wherein the present invention may be implemented;

FIGS. 5a and 5b are examples of multiple item price labels supported by an electronic pricing system according to the invention;

FIG. 6 is a diagrammatic illustration of the data frame structure for updating a multiple item price label according to the invention, and

FIG. 7 is a view similar to FIG. 6 further illustrating the data frame structure.

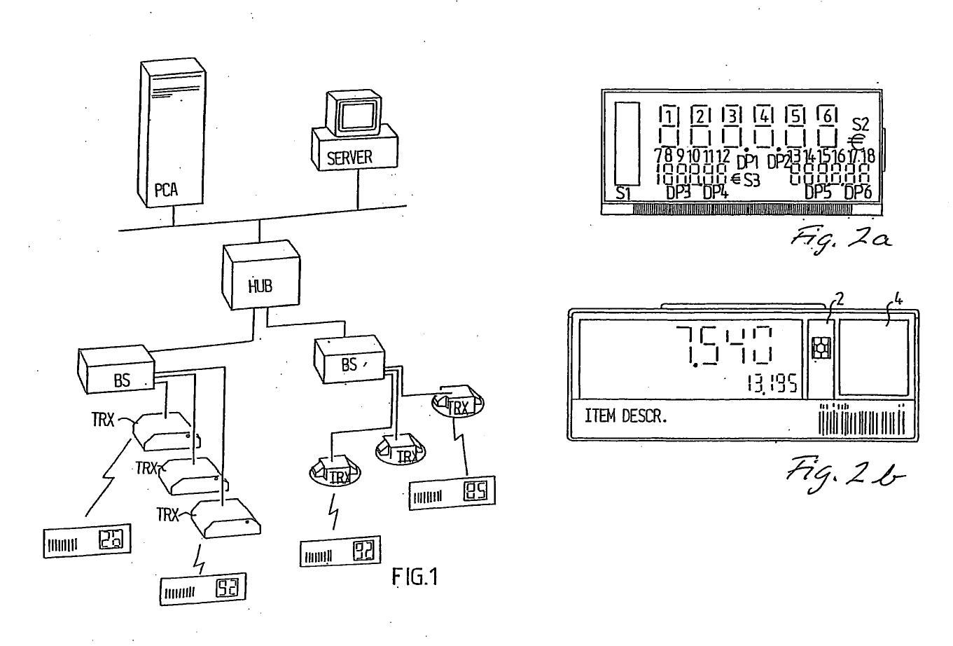

### DETAILED DESCRIPTION OF PREFERRED EMBODIMENTS

Definitions of different objects used to define an electronic price label are provided below. These objects may be tables, databases and in particular relational databases.

Price label type (PL type) describes the physical characteristics for a price label, e.g. communication protocol parameters and LCD display segments and how they are grouped. The characteristics of a PL type are described in a device file

Price label layout (PL layout) specification describes how to map item data on the label. A PL layout script that configures how to map data onto a specific PL type performs this. The script is defined in a layout script file that is compiled by the system at start-up. Each segment of the PL display is possible to control.

Price label model (PL model) contains information about how to apply information sent to the system over e.g. the PFI (Price File Interface) to the labels. The PL model contains information about layout scripts to use for different Item Presentation Forms (see below). In the price label server, the PL model optionally refers also to overlay type and layout. An overlay is an optionally used paper that is attached to the label's front end. The overlay may comprise information about the item, such as name, brand and weight.

Generally, PL model and PL layout script concern mapping of data and PL type concerns the physical characteristics of the price label.

An Item Presentation Form (IPF) is an abstraction of what information to display on a PL for an Item. It is passed as an Item property by the PCA. Thus it isolates the PCA from the PL layout scripts handled internally by the price label system. The references between IPF and PL layout scripts are kept within the PL model.

A typical electronic pricing system may comprise about 10000 price labels, each individually controlled by the system.

FIG. 3 shows a more detailed block diagram illustrating the relationships between different hardware and software objects in an electronic pricing system.

The Item and cross-reference, Xref, tables, together with the physical price labels, Price Label, are dynamic objects where the item table via Xref links each physical price label to the other objects. These other objects may be regarded as static objects whereas they are subject to changes only when the system is configured, both initially when the system is set up and when the system is updated e.g. new PL models or types are added.

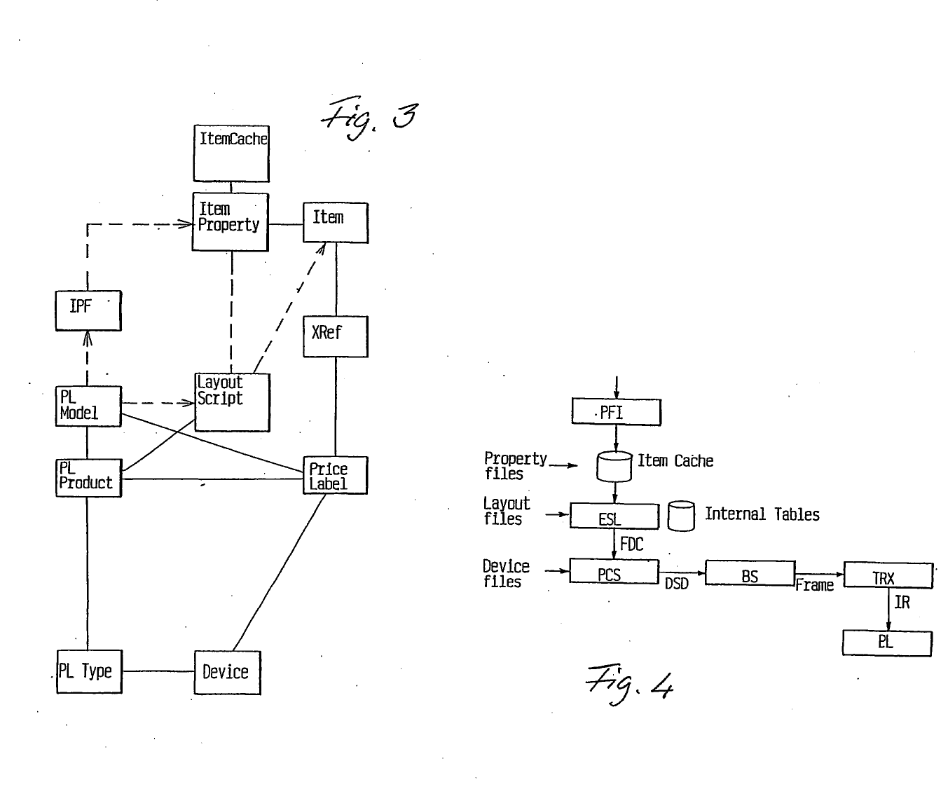

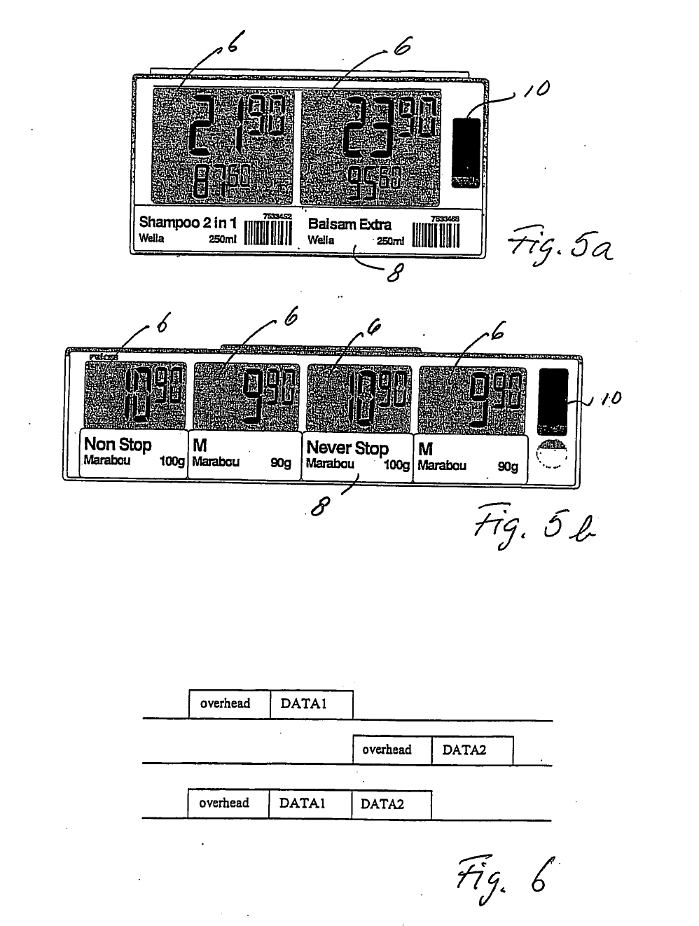

An ItemCache database stores data received from the PCA. In ItemProperty a property description file is arranged that contains item data and information how the data should be viewed in a graphical user interface (not shown in the figure). The Item Presentation Form (IPF) table comprises a high level description of the kind of information to be displayed on the Price Label. The other blocks in FIG. 3 are described above and in relation with the description of FIG. 4.

FIG. 4 shows the main blocks of an electronic pricing system. The system comprises a price file interface (PFI) where data, e.g. new price of an item, is received in the form of a PFI data file from the store's PCA-system (not shown in the figure). The received data is stored in an item cache database and a request to create an update job is generated. A property description file contains item data and information how the data should be viewed in a graphical user interface (GUI) in a client (not shown in the figure) connected to the server.

The request for updating a PL is applied to the “electronic shelf edge label” management block (ESL) that handles the connection between item and price label by accessing item and label information from the item cache database and also from internal tables in the ESL-block. To determine which information to send out to an individual PL, the PL's associated PL layout script file is executed based on information in the associated PL model, using the IPF to select the appropriate layout script. The layout script files describe how to map item data onto the price label. There are a number of layout script files for each PL type. When the layout script is executed, the output from the layout script is transformed into a format called “field data contents” (FDC) containing the data to send.

The FDCs are collected in a batch in the “price communication service” (PCS) block. The PCS block converts, by using “device files” and by using the settings in an associated communication protocol, the FDC data to frames which are collected into a “device specific data” (DSD) that in turn is transferred to a sending queue. The “device files” define how to display the data on the label. There is one device file for each PL type. The PL product representing the physical PL associates the model, the layout script and the PL type.

DSDs from the sending queue are then transmitted to the base station (BS) and further in the form of data frames via the transceivers (TRX) sent to the price labels (PLs).

Below is an overview of the price changing process in a pricing system according to a preferred embodiment of the present invention wherein two or more items are associated with an individual price label:
1. The price label system server receives a price file containing item identification and the new information, e.g. price, from the store's PCA-system.
2. Find the item in a database and get the identity of all PLs that are linked to this item.
3. For each PL linked to the item: Calculate frame data using all items linked to that PL.
4. Get the PL model to be used.
5. Determine which layout script to use, based on the IPF from the PL model.
6. Execute the layout script, and perform all the steps needed to generate the data frame that is to be transmitted to the target PL.
7. Determine in which sub-cell the PL is located.
8. Get communication settings from the communication protocol object associated with the determined sub-cell.
9. Transmit the frame to a base-station and further to the transceivers in the determined sub-cell for communication to the price label using the communication parameters specified in the protocol object.

The above method is executed in an electronic pricing system comprising a price label system server adapted to communicate with a price controlling application (PCA) server, communicating price label information to price labels (PLs). The system is designed to generate control signals for updating price information related to at least two separate sales items that are both/all logically linked to an individual price label in the system, and the price label is designed to receive the control signals and to display the price information for each item separately.

Thus there is suggested an electronic price label for an electronic pricing system, comprising price label system server adapted to communicate with a price controlling application (PCA) server communicating price label information to the price labels (PLs) in the system. The price label is logically linked to at least two separate sales items, and adapted to display price information related to each item separately.

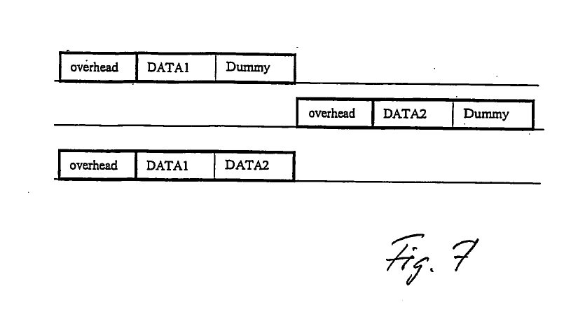

FIGS. 5a and 5b are illustrating examples of electronic price labels according to the invention, the price label of FIG. 5a being logically linked to two separate items, and the price label of FIG. 5b being linked to four separate items, respectively. Other configurations, naturally, would likewise be possible. In both examples, the price label front area is occupied by a display area 6 displaying price information associated with separate items listed in the PCA database. The display may be a segment mapped or a dot matrix display (preferably LCDs). The layout on the display 6 is controlled by the layout script file for the subject price label model, and each item may be associated with a separate display, or a single display may be controlled to show the prices for all items linked to that price label. Also on the front area, space 8 may be reserved for an adhesive overlay carrying printed static information associated with the items that are linked to the price label. In the case of updating by infrared light, an IR communication window 10 is arranged on the price label front.

The adhesive overlay may be printed with an item identification barcode identifying all items linked to the subject price label. Alternatively, separate barcodes are printed on the overlay, each barcode identifying a singular one of the two or more items linked to that price label. The item identification may also alternatively be stored in the price label and sent to a hand held device upon request, using any conceivable communication method.

An electronic pricing system, that supports and controls the displaying of price information related to separate items on the multiple item price labels of FIGS. 5a and 5b, clearly benefits from a reduced overhead of viewable surface in terms of surrounding walls of the price label casing, communication windows, and peripheral, non-effective display areas. Another benefit resides in the fact that internal physical components such as power source, communication interface, display drive components and controls, etc., may be shared by two or more items thus significantly reducing the costs for components, production and installation. It will be readily appreciable, that the invention: a) makes possible a significant reduction of the total number of price labels in the system, b) provides further alternatives in rearrangement of items on the shelves, c) permits a more condense display of small sized items, d) overrules the limitations for downscaling of price label size, set by the physical components that supplies and supports the price information display.

It is also foreseen, and diagrammatically illustrated in FIG. 6, that security and updating speed is enhanced through reduction of data overhead. By linking several items to one price label ID, updating data for all items displayed on that price label may be simultaneously transmitted and the data overhead, such as price label address, command, checksum etc., shared by the updating data for all separate items included in the data frame. In the system, the links between items and the subject price label are used in such way that price label ID will be determining for the number of item specific data fields (DATA1, DATA2, etc.) to be included in the data frame, and multiple item specific data being assembled with data overhead and simultaneously transmitted to the price label.

The saving of time is further illustrated in FIG. 7. If communication protocol is fixed at a data size that is at least double the amount (including dummy bits) that is needed for one item, then the same data communication protocol may be used for two items and in this case one message is sent instead of two, and hence the transmission speed is doubled. It is realized, that a reduction of transmitting time causes a corresponding reduction of active receiving and energy consumption in the price label.

The present invention is not limited to the above-described preferred embodiment adapted for mounting on a shelf edge. Various alternatives, modifications and equivalents may be used, such as individual price labels linked to two or more fruit and vegetable products, menu labels, etc. Other modifications may include dual display modes, whereby normally hidden information stored in the price label may be brought forward by manual actuation or through a time sharing control logic included in the display drive, e.g. Therefore, the above embodiments should not be taken as limiting the scope of the invention, which is defined by the appending claims.

1. An electronic pricing system, comprising price label system server adapted to communicate with a price controlling application (PCA) server communicating price label information to price labels (PLs), characterized in that the system is designed to generate control signals for updating price information related to at least two separate sales items that are both/all logically linked to an individual price label in the system, said price label being designed to receive the control signals and to display the price information for each item separately.

2. The electronic pricing system of claim 1, wherein a price label is defined through price label type, price label layout script and price label model, characterized in that the system generates and transmits frame data comprising multiple item data related to items that are logically linked to an individual price label in the system and based on the price label layout script, price label model and price label type, the price label being designed to receive the data frame and separate the item data for displaying price information associated with the separate items.

3. The electronic pricing system of claim 1, characterized in that the system generates frame data containing updating data related to each item linked to the price label, the price label simultaneously updating the price/prices of all items linked to the subject price label.

4. The electronic pricing system of claim 1, characterized in that price label ID determines the number of item specific data fields included in the data frame, and multiple item specific data being assembled with data overhead and simultaneously transmitted to the price label.

5. An electronic price label, in an electronic pricing system comprising price label system server adapted to communicate with a price controlling application (PCA) server communicating price label information to price labels (PLs) in the system, characterized by being logically linked to at least two separate sales items, and adapted to display price information related to each item separately.

6. The electronic price label of claim 5, wherein the price label is defined through price label type, price label layout script and price label model, characterized by being adapted to receive frame data comprising multiple item data related to items that are logically linked to the price label in the system and based on the price label layout script, price label model and price label type, the price label being designed to separate the item data for displaying price information associated with the separate items.

7. The price label of claim 5, characterized by separate displays for each item linked to the price label, said separate displays being supplied from common physical components included in the price label.

8. The price label of claim 5, characterized by a common display for all items linked to the price label, and said price label layout script controlling the display for separating price information related to each item linked to the price label.

9. The price label of claim 5, wherein the display is a dot matrix display, preferably an LCD display.

10. The price label of claim 5, wherein the display is a segment mapped display, preferably an LCD display.

11. The price label of claim 5, wherein each item linked to the price label is associated with an item identification code that is stored in the price label and sent to a hand held device upon request.

12. The application of an electronic pricing system and a price label according to claim 1 for displaying price information on shelf edges.

13. The application of an electronic pricing system and a price label according to 1 for displaying price information related to fruit and vegetable products.

14. The application of an electronic pricing system and a price label according to claim 1 for displaying price information on menu signs.

15. A method for controlling price information displayed by an electronic pricing system which supports price labels that are capable of displaying price information associated with at least two separate items linked to the price label, comprising the steps of:
transferring price information and item identification data from a price control application (PCA) server to a price label system server;
identify all price labels linked to the item;
for each identified price label: calculate frame data using all items linked to that price label, and
transmit the data frame to the price label.

16. The method of claim 15, comprising the steps of:
transferring price information and item identification data from a price control application (PCA) server to a price label system server;
identify all price labels linked to the item;
for each identified price label: calculate frame data using all items linked to that price label;
get the price label model, and determine which layout script to be used based on the item presentation form (IPF) from the model;
execute the layout script and generate a data frame to be transmitted to the price label;
get communication settings associated with the price label, and
transmit the data frame to the price label using the specified communication parameters.

17. Computer program product directly loadable into the internal memory of a processing unit in a price label system server, comprising the software code portions for performing the steps performed by the price label server or by the method according to claim 1, when said product is run on a price label system server.

18. Computer program product stored on a computer usable medium, comprising a readable program for causing a processing unit in a price label system server, to control an execution of the steps performed by the price label server or by the method according to claim 1.
